(19) United States
(12) Patent Application Publication
(10) Pub. No.: US 2026/0189836 A1
(43) Pub. Date: Jul. 2, 2026

(54) EARPHONE

(71) Applicant: Merry Electronics(Shenzhen) Co., Ltd., ShenZhen (CN)

(72) Inventors: Chih-Hung Liu, Taichung (TW); Chun-Hung Chang, Taichung (TW); Hung-Wei Chen, Taichung (TW); Cheng Yu Tsai, Taichung (TW)

(73) Assignee: Merry Electronics(Shenzhen) Co., Ltd., ShenZhen (CN)

(21) Appl. No.: 19/044,540

(22) Filed: Feb. 3, 2025

(30) Foreign Application Priority Data
Dec. 27, 2024 (TW) 113151074

(51) Int. Cl. H04R 1/10

(52) U.S. Cl. CPC H04R 1/1016; H04R 1/105

(57) ABSTRACT

An earphone adapted to be worn on an ear is provided. The earphone includes a wearing component and an acoustical component. The wearing component includes a rear positioning portion and an acoustic channel. The acoustical component is connected to the wearing component, and the acoustical component includes an acoustic chamber, and the acoustic chamber is connected to the acoustic channel. When the earphone is worn on the ear, the wearing component is located in a cavum conchae of the ear, and the rear positioning portion exerts a positioning force on a rear edge of the cavum conchae, so that the earphone is positioned in the ear. The acoustic channel corresponds to an ear canal of the ear.

### CROSS-REFERENCE TO RELATED APPLICATION

This application claims the priority benefit of Taiwan application serial no. 113151074, filed on Dec. 27, 2024. The entirety of the above-mentioned patent application is hereby incorporated by reference herein and made a part of this specification.

### BACKGROUND

### Technical Field

The disclosure relates to an earphone.

### Description of Related Art

When the modern earphone is worn on the ear, the supporting structure of the earphone only slightly rests on the edge of the cavum conchae of the ear, and cannot stably engage with the ear. Therefore, in more vigorous activity scenarios (for example, sports, wearing a hat, arranging hair, etc.), the earphone is prone to falling off the ear due to the accidental touch or the unexpected force, resulting in poor wearing stability of the earphone.

### SUMMARY

The disclosure provides an earphone with the better wearing stability.

The earphone of the disclosure is adapted to be worn on an ear. The earphone includes a wearing component and an acoustical component. The wearing component includes a rear positioning portion and an acoustic channel. The acoustical component is connected to the wearing component, and the acoustical component includes an acoustic chamber. The acoustic chamber is communicated with the acoustic channel. When the earphone is worn on the ear, the wearing component is located in a cavum conchae of the ear, the rear positioning portion exerts a positioning force on a rear edge of the cavum conchae, thereby positioning the earphone on the ear. The acoustic channel corresponds to an ear canal of the ear.

Based on the above, when the earphone of the disclosure is worn on the ear, the rear positioning portion of the wearing component exerts the active positioning force on the rear edge of the cavum conchae, so that the earphone is stably positioned on the ear, providing the earphone with the better wearing stability. At this time, the acoustic channel of the wearing component corresponds to the ear canal, so that the distance between the acoustic sound output channel and the ear canal is shorter, thereby reducing the degree of the signal energy attenuation from the earphone enters the ear canal, and improving the audio experience and the audio performance of the earphone.

### BRIEF DESCRIPTION OF THE DRAWINGS

FIG. 1 is a schematic view of an earphone according to an embodiment of the disclosure worn on an ear.

FIG. 2 is a cross-sectional view of the earphone of FIG. 1 worn on the ear.

FIG. 3 is a schematic view of the earphone of FIG. 1.

FIG. 4 is an exploded view of the earphone of FIG. 3.

FIG. 5 is an exploded view of an earphone according to another embodiment of the disclosure.

### DESCRIPTION OF THE EMBODIMENTS

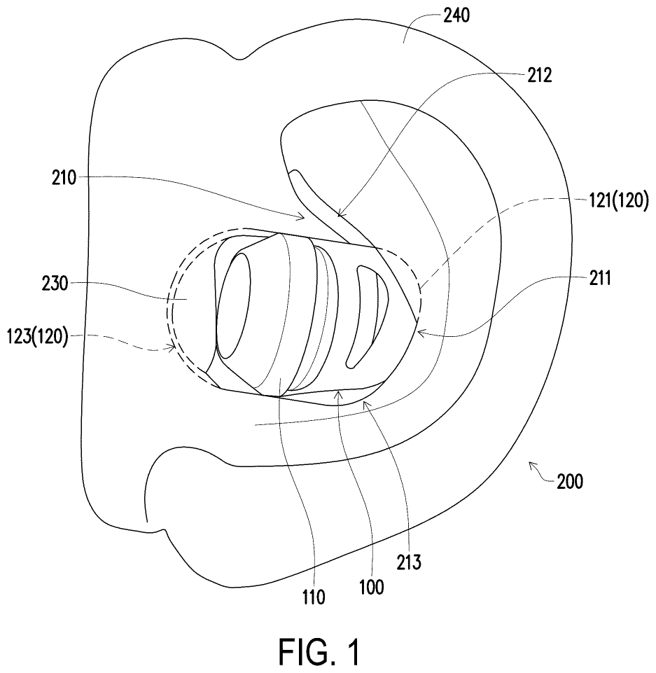

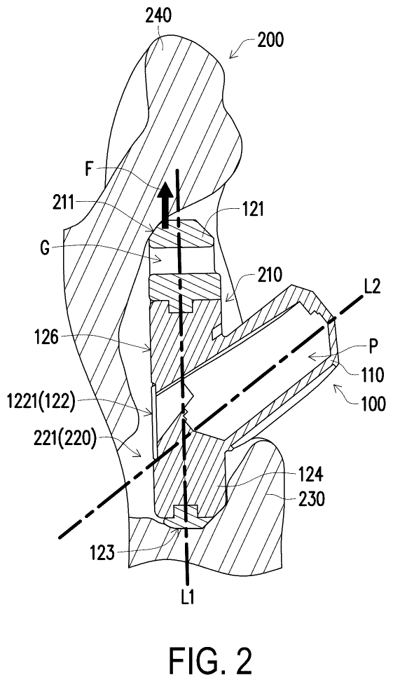

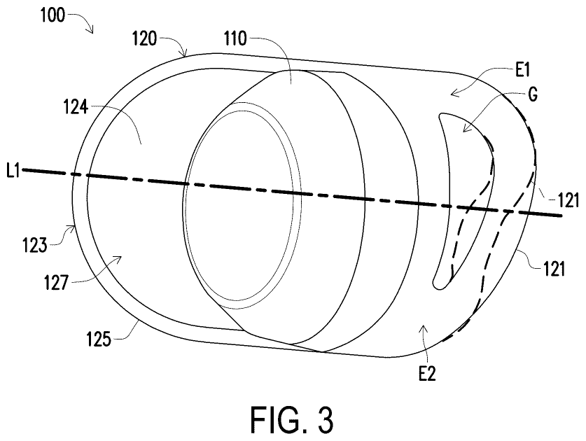

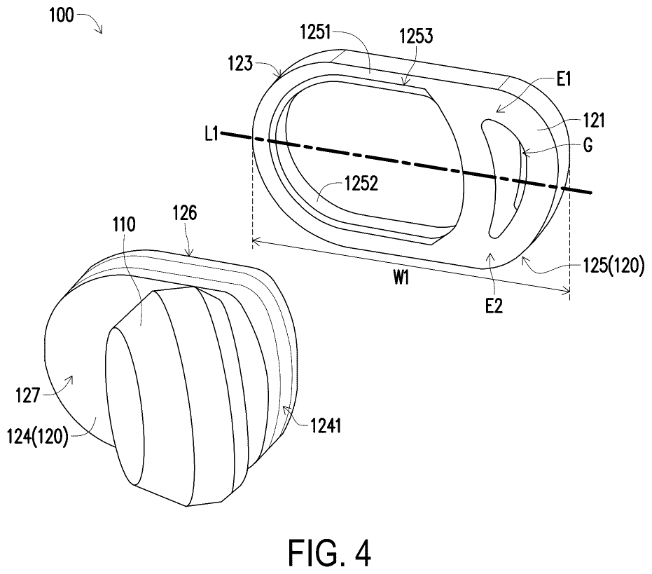

FIG. 1 is a schematic view of an earphone according to an embodiment of the disclosure worn on an ear. FIG. 2 is a cross-sectional view of the earphone of FIG. 1 worn on the ear. FIG. 3 is a schematic view of the earphone of FIG. 1. FIG. 4 is an exploded view of the earphone of FIG. 3. Please refer to FIG. 1 to FIG. 4 at the same time, the earphone 100 may be worn on an ear 200. The earphone 100 includes an acoustical component 110 and a wearing component 120. The acoustical component 110 is connected to the wearing component 120. The wearing component 120 includes a rear positioning portion 121 and an acoustic channel 122. The rear positioning portion 121 is located on an extension axis L1 of the wearing component 120, but not limited thereto. The acoustical component 110 includes an acoustic chamber P, and the acoustic chamber P is in communication with the acoustic channel 122. A plurality of acoustic elements and a plurality of electronic components (not shown) are disposed in the acoustic chamber P.

The cavum conchae 210 of the ear 200 includes a cymba conchae 212, a rear edge 211, and a bottom edge 213. The rear edge 211 connects between the cymba conchae 212 and the bottom edge 213, and faces the tragus 230 of the ear 200. The tragus 230 covers the ear canal 220 of the ear 200. When the earphone 100 is worn on the ear 200, the wearing component 120 is positioned in the cavum conchae 210 of the ear 200. The rear positioning portion 121 exerts a positioning force F on the rear edge 211 of the cavum conchae 210 to position the earphone 100 on the ear 200. The positioning force F specifically is a frictional force or a deformation force, but not limited thereto. The positioning force F may be parallel to the extension axis L1, but not limited thereto.

The resting structure of the known earphone conforms to the cymba conchae 212 or the bottom edge 213 of the cavum conchae 210, passively resting on the ear 200. Therefore, when the known earphone is accidentally touched or subjected to the unexpected force, the known earphone may easily fall off the ear 200 and lack stability. The resting structure of the known earphone needs to form a specially protruding structure to conform to the cymba conchae 212 or the bottom edge 213, thereby increasing the volume of the earphone, making the known earphone inconvenient for storage and wearing. The known earphone may also engage with the helix 240 of the ear 200 through the structure such as the ear hook, further increasing the volume of the earphone.

In this embodiment, when the earphone 100 is worn on the ear 200, the rear positioning portion 121 of the earphone 100 abuts against the rear edge 211 of the cavum conchae 210, thereby exerting the active positioning force F on the ear 200 to actively abut against the ear 200. Therefore, the earphone 100 is stably positioned in the ear 200 and not leave the ear 200 due to the accidental touch or the unexpected force, thus improving the wearing stability of the earphone 100. The rear positioning portion 121 of the earphone 100 is located on the extension axis L1 of the wearing component 120, thereby further reducing the volume of the earphone 100.

The wearing component 120 includes a sound output surface 126, and an acoustic sound output hole 1221 of the acoustic channel 122 is located on the sound output surface 126. When the earphone 100 is worn on the ear 200, since the wearing component 120 of the earphone 100 extends into the cavum conchae 210 of the ear 200, the sound output surface 126 of the earphone 100 faces the ear canal 220 of the ear 200, making the acoustic channel 122 correspond to the ear canal 220, and closer to the ear canal inlet 221 of the ear canal 220, thereby shortening the distance between the acoustic channel 122 and the ear canal 220. The degree of the signal energy attenuation of the audio from the earphone 100 entering the ear canal 220 is reduced due to the shorter distance between the acoustic channel 122 and the ear canal 220, thereby improving the audio experience and the audio performance of the earphone 100.

As shown in FIG. 2 and FIG. 3, the wearing component 120 further includes a front positioning portion 123. The front positioning portion 123 is located on the extension axis L1 of the wearing component 120, but not limited to this. When the earphone 100 is worn on the ear 200, the front positioning portion 123 extends into the cavum conchae 210 and is covered by the tragus 230 of the ear 200. The front positioning portion 123 is positioned between the ear canal 220 and the tragus 230 and abuts against the ear 200. Thereby, the earphone 100 is more stably connected to the ear 200.

As shown in FIG. 4, the wearing component 120 of this embodiment includes a wearing body 124 and a support component 125. The support component 125 is detachably and replaceably connected to the wearing body 124, but not limited thereto. The support component 125 includes a support body 1251, a rear positioning portion 121, and a front positioning portion 123. The acoustical component 110 is connected to a surface 127 of the wearing body 124 opposite to the sound output surface 126. The wearing body 124 includes a slot 1241, and the support body 1251 of the support component 125 includes a connecting opening 1253 and a protrusion 1252. The protrusion 1252 extends from an edge of the connecting opening 1253 towards a center of the support body 1251. The wearing body 124 may enter the connecting opening 1253, causing the protrusion 1252 to engage with the slot 1241, thereby connecting the support component 125 (the support body 1251) to the wearing body 124.

The front positioning portion 123 is located on one side of the support body 1251 and has an arc shape, but not limited thereto. Two ends E1, E2 of the rear positioning portion 121 are connected to the other side of the support body 1251, forming a hollow structure G between the rear positioning portion 121 and the support body 1251. In this embodiment, the material of the support component 125 is a soft material, and the support body 1251 and the rear positioning portion 121 are integrally formed, but not limited threreto.

FIG. 3 shows the deformed rear positioning portion 121 with dashed lines. As shown in FIG. 3, since the hollow structure G between the rear positioning portion 121 and the support body 1251, when the earphone 100 is worn on the ear 200, the rear positioning portion 121 may be pressed and deformed by the cavum conchae 210 to generate the positioning force F, actively abutting against the rear edge 211 of the cavum conchae 210. The earphone 100 is adapt to ears 200 of different shapes through the deformation of the rear positioning portion 121, thereby improving the usability of the earphone 100 and enhancing the connection strength between the earphone 100 and the ear 200.

The structure and material of the rear positioning portion 121 and the front positioning portion 123 are not limited to this embodiment. In an embodiment not shown, there may be no hollow structure G between the rear positioning portion 121 and the support body 1251, and when the earphone 100 is worn on the ear 200, the rear positioning portion 121 may still deform to generate the positioning force F. In an embodiment not shown, the front positioning portion 123 may have the same structure as the rear positioning portion 121. In an embodiment not shown, the material of the support component 125 may be a non-soft material. In this embodiment, an extension axis L2 of the acoustical component 110 is different from the extension axis L1 of the wearing component 120, causing the acoustical component 110 to be inclinedly connected to the wearing component 120, but not limited thereto. In an embodiment not shown, the earphone 100 may be a true wireless stereo (TWS) earphone.

Moreover, the earphone 100 in this embodiment is an open-type earphone, but not limited thereto. The earphone 100 may include an atmosphere sound channel (not shown) to transmit the environmental sounds into the ear 200. In an embodiment not shown, the earphone 100 may be a closed-type earphone.

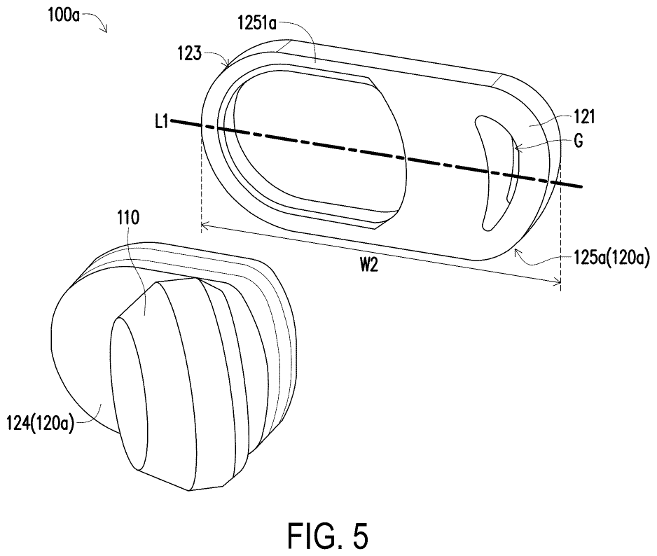

FIG. 5 is an exploded view of an earphone according to another embodiment of the disclosure. Please refer to FIG. 4 and FIG. 5 at the same time, the earphone 100a of this embodiment is similar to the previous embodiment. The difference between the two is that the support body 1251a of the wearing component 120a in this embodiment has a longer length, making a length W2 of the support component 125a along the extension axis L1 longer. The length W2 of the support component 125a in FIG. 5 is greater than a length W1 of the support component 125 in FIG. 4, allowing the earphone 100a of this embodiment to better adapt to ears of different shapes. The earphone 100a of this embodiment has the same effect as the previous embodiment, and is not repeated herein.

In summary, when the earphone of the disclosure is worn on the ear, the rear positioning portion of the wearing component exerts the active positioning force on the rear edge of the cavum conchae, so that the earphone is stably positioned on the ear, providing the earphone with the better wearing stability. At this time, the acoustic channel of the wearing component corresponds to the ear canal, so that the distance between the acoustic sound output channel and the ear canal is shorter, thereby reducing the degree of the signal energy attenuation from the earphone enters the ear canal, and improving the audio experience and the audio performance of the earphone.

What is claimed is:

1. An earphone, adapted to be worn on an ear, the earphone comprising:
a wearing component, comprising a rear positioning portion and an acoustic channel; and
an acoustical component, connected to the wearing component, the acoustical component comprises an acoustic chamber, the acoustic chamber is communicated with the acoustic channel,
when the earphone is worn on the ear, the wearing component is located in a cavum conchae of the ear, the rear positioning portion exerts a positioning force on a rear edge of the cavum conchae, thereby positioning the earphone on the ear, the acoustic channel corresponds to an ear canal of the ear.

2. The earphone as claimed in claim 1, wherein the wearing component comprises a wearing body and a support component, the support component is detachably connected to the wearing body, the support component comprises the rear positioning portion, the acoustical component is connected to the wearing body.

3. The earphone as claimed in claim 1, wherein the wearing component comprises a wearing body and a support component, the support component comprises a support body, two ends of the rear positioning portion are connected to the support body, a hollow structure is formed between the rear positioning portion and the support body, the support body is detachably connected to the wearing body.

4. The earphone as claimed in claim 1, wherein the wearing component comprises a support component, the support component comprises a support body, the rear positioning portion is connected to the support body, when the earphone is worn on the ear, the rear positioning portion deforms to generate the positioning force.

5. The earphone as claimed in claim 1, wherein the wearing component comprises a front positioning portion, when the earphone is worn on the ear, a tragus of the ear covers the front positioning portion, the front positioning portion abuts against the ear.

6. The earphone as claimed in claim 1, wherein the wearing component comprises a sound output surface, an acoustic sound output hole of the acoustic channel is located on the sound output surface, when the earphone is worn on the ear, the sound output surface faces an ear canal of the ear.

7. The earphone as claimed in claim 1, wherein the earphone is an open-type earphone.
